(19) United States
(12) Patent Application Publication
(10) Pub. No.: US 2019/0268333 A1
(43) Pub. Date: Aug. 29, 2019

(54) METHOD FOR OPERATING A COMMUNICATION DEVICE OF A MOTOR VEHICLE

(71) Applicant: AUDI AG, Ingolstadt (DE)

(72) Inventor: Konstantin WILLMANN, Ingolstadt (DE)

(73) Assignee: AUDI AG, Ingolstadt (DE)

(21) Appl. No.: 16/348,317

(22) PCT Filed: Oct. 27, 2017
(86) PCT No.: PCT/EP2017/077536

§ 371 Date: May 8, 2019

(30) Foreign Application Priority Data
Nov. 30, 2016 (DE) 10 2016 223 862.0

(51) Int. Cl. H04L 29/06; H04L 9/06; B60R 25/25; B60R 25/24; B60R 25/20

(52) U.S. Cl. CPC H04L 63/0861; H04L 9/0643; B60R 25/252; B60R 2325/108; B60R 25/209; B60R 2325/205; B60R 25/24

(57) ABSTRACT

The disclosure relates to a method for operating a communication device of a motor vehicle. A sensor device captures an identification feature, on the basis of which a user of a user profile stored in a motor-vehicle-external data server apparatus is identifiable, for example a feature of a mobile terminal of the user or of the user, for example a fingerprint. On the basis of the captured identification feature, an identification device of the motor vehicle establishes an identity of the user. Depending on the established identity, the identification device establishes an access code for the user profile of the user, wherein the at least one access code is stored in a database, and the established access code is used to enable the ascertained user profile for the communication apparatus.

The invention relates to a method for operating a communication device of a motor vehicle, which is adapted to provide a data communication connection to a motor-vehicle-external data server apparatus and to communicate with the motor-vehicle-external data server apparatus. For this purpose, the communication device can be adapted to transmit and/or receive data via, for example, an Internet or WLAN connection or for near-field communication. The communication device may have, for example, an operating device, that is to say an equipment component or an equipment for receiving operator actions, which may be configured, for example, as a keyboard or touch-sensitive screen. Alternatively, the communication device may be connected to the operating device, for example via a data bus system of the motor vehicle.

To personalize settings of a motor vehicle, an identification of a current user of the motor vehicle is required. In doing so, for example, a user-specific seat adjustment or an authorization to start the engine can be set. Currently, for example, a vehicle key or a personal smartphone of the vehicle user are available as ID transmitter, thus equipment that can give the identity to the motor vehicle. For example, the personal smartphone can be used via near field communication (“NFC”) or by using a Bluetooth Low Energy (“BLE”) connection. The same ID transmitter are currently available for access control, i.e. a classic car key or a personal smartphone.

However, traditionally used vehicle keys are often used by multiple people, which means that a person can not be identified on the basis of the vehicle key. For use and personalization of other functions, a PIN input in the motor vehicle is thus additionally required.

For vehicle access, the I/D transmitter must always be carried, i.e., either the key or the smartphone with an RLU function (via vehicle-to-infrastructure services or via a multimedia interface (“MMI”) software), and usually only an opening of the motor vehicle is possible.

DE 20 2005 009 252 U1 describes a method for user identification in motor vehicles by means of a biometric fingerprint. The fingerprint can be used to unlock the vehicle, start the engine and drive the vehicle.

From DE 199 03 434 A1 a method for controlling individual settings in a motor vehicle is known, wherein a fingerprint of the user is recorded before entering the vehicle by means of a portable unit.

Finally, U.S. Pat. No. 6,100,811 1A describes a method for carrying out user-specific vehicle settings depending on a user's fingerprint.

The prior art thus describes equipment that correspond to a personalized car key.

By the methods of the prior art, motor-vehicle-internal settings can be made and basic functions such as turning on the engine and unlocking the motor vehicle can be activated. However, in order to use all the entertainment functions and comfort services of the motor vehicle, the user of the motor vehicle still needs additional keys or passwords as an identification transmitter, which he always has to carry or remember. Such additional keys or passwords are always at risk of being lost or stolen.

One object of the invention is to increase safety in using a motor vehicle and related services.

The object is achieved by the method according to the invention and the devices according to the invention of the independent claims. Further advantageous developments are given by the dependent claims.

The invention is based on the idea, by means of an identification feature on the basis of which a user of a user profile can be identified, by means of an identification device of the motor vehicle to establish access codes for a user profile of the identified user and thus to enable the user profile. This increases security in using the user profile and associated services.

The method according to the invention for operating a communication device of a motor vehicle initially has a method step in which a sensor device captures the identification feature, based on which the user of the user profile is identifiable, wherein the identification feature is a feature of a mobile terminal of the user or a feature of the user. The user profile can be stored, for example, in the identification device or on a motor-vehicle-external data server apparatus. Here, the communication device is adapted to provide a data communication connection to the motor-vehicle-external data server apparatus and to communicate with the motor-vehicle-external data server apparatus. Motor-vehicle-external equipment is provided as data server apparatus that is adapted for data processing and may comprise, for example, a data server or a so-called “backend”, for example a program running on a server.

On the basis of the captured identification feature there is an establishing of an identity of the user by an identification device of the motor vehicle. The identification device is equipment or an equipment component that is adapted to evaluate a sensor signal that describes the detected identification feature. Furthermore, the identification device is adapted to generate control signals. For example, if the identification feature is a serial number or S-PIN of a user's mobile terminal, the identification device may compare the serial number or S-PIN with a stored serial number or S-PIN, for example, and if the serial numbers or S-PINs match ascertain and thus establish the identity of the user.

By means of the identification device and depending on the established identity the access code to a user profile of the user is established, whereby the at least one access code is stored in a database. The access code can be, for example, a password and stored, for example, in a database of the motor vehicle. Alternatively, the access code may be stored in a database stored in the motor-vehicle-external data server apparatus. The communication between the communication device and the data server apparatus takes place here via the data communication connection.

By means of the established access code, via the data communication connection, the established user profile is enabled, whereby the user profile for the communication device and thus for the user is enabled.

For such an identification for the personalization of services that can be used via the motor vehicle, an identification and/or authentication of the user can be made, for example, who has just turned off his smartphone or forgot his password. The identification and/or authentication is not dependent on a performance of other equipment, so for example dependent on the fact that a software of the smartphone functions to be able to use the online service. Furthermore, there is a one-time link of the identification feature and the user profile and thus enables identification of the user in all motor vehicles, for example, also in rental cars. Furthermore, for example, an authentication can take place in an online update in the motor vehicle. An identification and/or authentication is possible with the method according to the invention during a drive, without the user being distracted. It also eliminates annoying and repetitive login procedures, such as password entry, which significantly increases the convenience of personalized use of online services.

The method according to the invention also makes it possible to authenticate in-car purchases, for example, in an in-car web shop, that is to say of online purchases with a payment service, and the method leads to an increase in the comfort of such processes.

It may be provided, for example, that the identification feature can be, for example, a serial number or an S-PIN of the mobile terminal of the user. However, using a smartphone may require additional authentication, such as unlocking the smartphone by entering a PIN. Furthermore, the smartphone must be turned on and provide an authentication path, for example via NFC or BLE.

Such an authentication path must then be activated, which in some cases is associated with increased energy consumption. If the smartphone is not available, the identification for a specific profile in the vehicle is again only possible via a password. Should it be necessary to download a profile from the data server apparatus in another motor vehicle, for example in a new car, personal information must be completely reentered, as well as, for example, the password.

By means of the method according to the invention, according to a further embodiment, the enabled user profile can be called up. For this purpose, for example, a user interface of the user profile can be output by an output device, i.e. equipment or an equipment component for outputting, for example, an audio signal and/or an image signal, so that the user can operate the user profile.

According to a particularly preferred embodiment of the method according to the invention, a biometric feature of the user can be captured as an identification feature, preferably a fingerprint of the user or a structure an eye iris of the user. Every user, even without a smartphone, can be identified via the biometric identification feature. This results in increased protection of profile data, since the biometric feature can not be stolen, copied or read upon input, and also can not be forgotten by the user. This also results in increased protection for, for example, data from credit cards or other personal information stored in a user profile. For example, if the motor vehicle has a fingerprint reader on a door handle or on, for example, a start-stop button of the motor vehicle, the user profile will be enabled by an intuitive action of the user. As a result, the user is even less distracted from, for example, a driving event.

Establishing the identity by the identification device of the motor vehicle can take place, for example, in that the identification device itself ascertains the identity, that is, for example, compares a fingerprint of the user with a fingerprint stored in a database of the identification device. Alternatively it may be provided that the identification device establishes the identity in that the motor-vehicle-external data server apparatus assumes establishing the identity and informs the identification device of the motor vehicle accordingly. For this purpose, it may be provided that the identification device of the motor vehicle carries out a generation of an identifier representing the identification feature. In this case, the identifier representing the identification feature is a specific identifier and may preferably comprise a code which specifically represents the identification feature and may optionally have a smaller data volume than the data signal that describes the captured identification feature. The identifier may in particular comprise a hash code, in particular a checksum, a hex string, a code generated by means of a SHA1 algorithm or an md5 checksum. In this case, the identifier is an encrypted code.

The generated identifier may be transmitted to the motor-vehicle-external data server apparatus for ascertaining the identity. In order to ascertain the identity, the motor-vehicle-external data server apparatus can, for example, have a key for decrypting the identifier and recognize or read out the identification feature. The identification device can then receive from the motor-vehicle-external data server apparatus an authentication signal that can describe the identity ascertained by the motor-vehicle-external data server apparatus, wherein establishing the identity by the identification device can be on the basis of the authentication signal. In other words, the authentication signal may, for example, name the identity of the user.

The identifier can be transmitted, for example via the data communication connection. In other words, the exemplary matching of the exemplary fingerprint can be outsourced from the motor vehicle. As a result, the method according to the invention is applicable to many more motor vehicles, because even if the motor vehicle does not belong to the user, such as a rental car, the data necessary to verify the identification does not need to be stored in this rental car.

The sensor device may preferably be a sensor device of the motor vehicle. Alternatively, however, the capturing of the identification feature can also take place via a sensor device of a mobile terminal, that is, for example, by a sensor device of a smartphone or tablet PC or laptop. According to this embodiment of the method according to the invention, generating the identifier representing the identification feature can be carried out by an identification device of the mobile terminal. The generated identifier can then be transmitted, for example by a communication device of the mobile terminal, to the identification device of the motor vehicle for establishing the identity and/or for ascertaining the identity. This can be done for example via an Internet connection or via a Bluetooth connection between the mobile terminal and the communication device of the motor vehicle. This embodiment of the method according to the invention makes it possible to use a motor vehicle for the method according to the invention which has no corresponding sensor device. Such a motor vehicle then does not have to be retrofitted costly with, for example, a fingerprint reader.

As already mentioned above, the generation of the identifier representing identification feature can comprise creating a cryptographic hash function as identifier. Preferably, this can be done by creating a checksum, and/or a hex string and/or a hash-code by means of an SHA1 algorithm and/or an md5 checksum.

In order to simultaneously facilitate operation of a motor vehicle system, for example an auxiliary heater or an ignition device, which below is understood to mean a motor vehicle system with an ignition system, a further embodiment of the method according to the invention can provide that, depending on the established identity and a predetermined function of the user profile for activating to control a motor vehicle system, it is possible to generate a control signal for activating a predetermined function of the motor vehicle system of the motor vehicle. The control signal can be generated for example by the identification device of the motor vehicle. There is a transmission of the control signal to the motor vehicle system. In this way, personalized user rights can be taken into account, wherein, for example, information can be stored in the identification device which indicates which user is authorized to use the auxiliary heater or the ignition device, for example. Alternatively, the automotive system may be, for example, a system for starting and/or stopping an engine.

The object set out above is likewise achieved by an identification device, comprising a processor device, wherein the processor device is adapted to carry out the method steps of a method according to any one of the embodiments described above relating to an identification device. A processor device is here an equipment component for data processing and may have, for example, a microprocessor and/or a microcontroller. As a result the above advantages are obtained.

The above object is also achieved by a motor vehicle, which may preferably be configured as a motor vehicle, for example as a passenger car. The motor vehicle has an embodiment of the identification device according to the invention, and a communication device. Again, as a result, the above advantages are obtained.

According to a further embodiment of the motor vehicle according to the invention, the latter can have a sensor device for capturing the identification feature, preferably wherein a sensor of the sensor device can be arranged on a door handle of the motor vehicle and/or on a motor vehicle system of the motor vehicle. In particular, the sensor can be arranged on an operating element of a motor vehicle system for starting and/or stopping an engine or on an ignition device of the motor vehicle.

The invention also includes developments of the method according to the invention, which have features as have already been described in connection with the developments of the motor vehicle according to the invention. For this reason, the corresponding developments of the method according to the invention are not described again here.

AN exemplary embodiment of the invention is described below. For this purpose, the sole FIGURE (“FIG.”) shows:

a schematic diagram of an embodiment of the method according to the invention.

The exemplary embodiment explained below is a preferred embodiment of the invention. In the exemplary embodiment, the described components of the embodiment each represent individual features of the invention that are to be considered independently of one another, which develop the invention further also independently of one another and thus also must be considered individually or in a different combination than the one shown as part of the invention. Furthermore, the described embodiment can also be supplemented by further features of the invention already described.

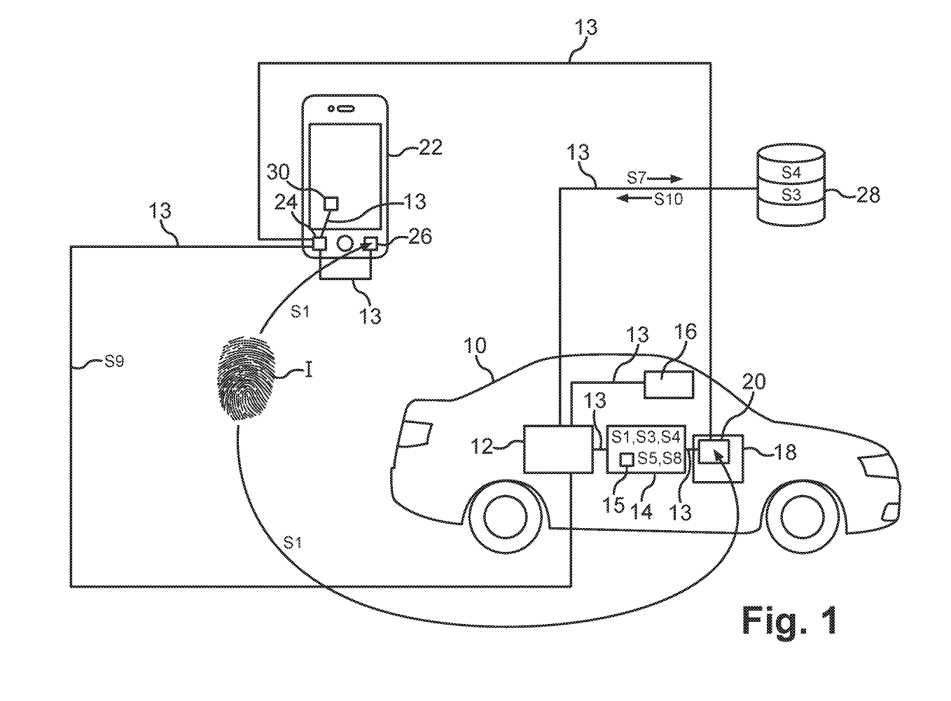

In the FIGURE, functionally identical elements are each provided with the same reference numerals. FIG. 1 exemplarily illustrates the method according to the invention with reference to an exemplary embodiment. For this purpose, the FIGURE shows a motor vehicle 10 that, for example, can be configured as a motor car, for example, as a passenger car.

The motor vehicle has a communication device 12, which as equipment is equipped, for example, with a transmitter and/or a receiver and is adapted for communicating with other equipment or devices of motor vehicle 10 on the one hand, and with motor-vehicle-external equipment or devices on the other hand. Communication device 12 can be adapted, for example, for near-field communication and, for example, have a corresponding NFC chip for this purpose. Additionally or alternatively, communication device 12 may be adapted to establish a WLAN connection and/or an Internet connection and/or a BLE use. Corresponding techniques are known to the person skilled in the art from the prior art.

In the example of the FIGURE, communication device 12 is connected to an identification device 14 via, for example, a wired data communication connection 13, for example via a data bus system of motor vehicle 10. Identification device 14 may optionally have a processor device 15, which may have, for example, a microprocessor and/or a microcontroller. In this case, identification device 14 can be configured, for example, as a control board, which can optionally have, for example, a memory device, such as a memory chip or memory card. In the memory device (not shown in the FIGURE), for example, a database may be stored in which, for example, information about a fingerprint of a user may be stored.

In the example of the FIGURE, communication device 12 of motor vehicle 10 may be connected to an operating device 16 of motor vehicle 10. Alternatively, operating device 16 may also be a component of communication device 12, for example a keyboard or a system for gesture recognition or a system for speech recognition. Corresponding techniques are known to the person skilled in the art from the prior art.

Motor vehicle 10 of the FIGURE also has, by way of example, a motor vehicle system 18 that can be configured, for example, as a locking system of motor vehicle 10, door handle, or as a system for starting and/or stopping an engine of motor vehicle 10, or as a system with an ignition system.

In the example of the FIGURE, motor vehicle system 18 may have a sensor device 20. Alternatively, however, sensor device 20 may be arranged structurally separate from motor vehicle system 18. Alternatively, motor vehicle 10 may be equipped without sensor device 20. For example, sensor device 20 may have a fingerprint reader that may be arranged on the exemplary door handle. Alternatively, the exemplary fingerprint reader can also be arranged, for example, on an operating element of mentioned motor vehicle system 18 for starting and/or stopping the engine, wherein the operating element is understood to be a component for receiving an operating action which for example can be configured as a key or rotary actuator.

Further alternatives of sensor device 20 may have, for example, a scanner for scanning an eye iris, and/or a receiver for receiving a recognition code of a mobile terminal 22, for example for recognizing the S-PIN or the serial number. An exemplary scanner, that is to say a reader, can be arranged, for example, on a location of motor vehicle 10 that is easily accessible ergonomically while driving, for example on an operating element of a multimedia interface (“MMI”).

In the example of the FIGURE, mobile terminal 22 can be configured as a smartphone. Said smartphone may have, for example, a sensor device 26 and a communication device 24. In this case, communication device 24 of the mobile terminal can establish a data communication connection 13 with communication device 12 of motor vehicle 10. Examples have already been mentioned above.

The mobile terminal may optionally also have an identification device 30, which may have the above-described properties of an identification device.

In the example of the FIGURE, sensor device 20, for example sensor device 20 of motor vehicle 10, captures in a first method step S1 identification feature I, which may be, for example, a fingerprint. For example, this can be done when the user touches a corresponding sensor on a door handle of motor vehicle 10, or if the user, for example, already sits in motor vehicle 10 and touches a button of motor vehicle system 18, for example, to start the engine of motor vehicle 10 with the button. If motor vehicle 10 has not started yet at this time, for example, then a separate power supply for sensor device 20 and/or identification device 14 may be provided. In the two examples mentioned, the user performed an intuitive action in which the identification feature I is captured simultaneously (S1). If a sensor of sensor device 20 is configured, for example, as a button, which may be arranged next to a multimedia interface, touching the sensor is an intended action of the user for capturing identification feature I.

If motor vehicle 10 is used by several users, for example, the respective user can be identified quickly without having to hand over a key from one user to the next user.

Identification device 14 determines the identity of the user in method step S2. For this purpose, for example, sensor device 20 can transmit a signal that can describe the fingerprint, via data communication connection 13 to identification device 14. In order to establish the identity (S2), the identification device can compare the detected fingerprint, for example, with files of a motor-vehicle-internal database, which, for example, can describe the fingerprints of the various users.

In the case of a positive result of the comparison, the identity can thus be deduced and thus established (S2).

In method step S3, the identification device can then establish an access code of a user profile of the user (S3), wherein the user profile can be, for example, a customer profile of the user on motor-vehicle-external data server apparatus 28, i.e., for example, a customer profile on a data server of the motor vehicle manufacturer. Alternatively or additionally, the user profile may be a profile of a social network or a profile of an online service through which the user may, for example, purchase products over the Internet. In this case, according to the method according to the invention, more than one access code can be established (S3), and multiple user profiles can be unlocked (S4). The user profile on the exemplary data server of the motor vehicle manufacturer can, for example, offer the user so-called “in-car apps”, for example additional functions for motor vehicle 10, which can be purchased for payment via a payment function in order, for example, to increase engine power.

The determined user profile (S4) can be unlocked by communication device 12 using the determined access code, wherein communication device 12 can log in or register at the user profile using the access code, for example, according to a method familiar to a person skilled in the art. This can be done via data communication connection 13 between communication device 12 of motor vehicle 10 and external data server apparatus 28.

Establishing the identity of the user (S2) can alternatively be done in that motor-vehicle-external data server apparatus 28 ascertains the identity (S6) and can transmit an authentication signal to communication device 12 and further to identification device 14, which can describe and/or confirm the identity. On the basis of the information of the received (S8) authentication signal, the identity can then be established by identification device 14 (S2). For secure data transmission, identification device 14 can, for example, convert the signal describing the exemplary fingerprint into a hash code, for example, and thus generate an identifier representing identification feature I (S5). Techniques for decrypting an encrypted signal/or identifier are known to the person skilled in the art from the prior art. This identifier can then be transmitted to data server apparatus 28 for ascertaining the identity (S6) (S7). The transmission of the identifier (S7) can be done with communication device 12. Enabling the user profile (S4) can also be performed by data server apparatus 28, for example.

Ascertaining the identity (S6) by data server apparatus 28 is advantageous if motor vehicle 10 is, for example, a rental car in which identification features I of various users are not present, for example because a user does not want his fingerprint permanently stored in a rental car company and thus in a foreign vehicle 10.

The FIGURE shows an alternative example for capturing the identification feature, according to which identification feature I can be captured by sensor device 26 of mobile terminal 22 (S1). In this case, by way of example, a fingerprint sensor can be utilized, which can be integrated in mobile terminal 22. A sensor signal describing identification feature I can then be transmitted to identification device 14 of motor vehicle 10 in method step S9. In this case, the sensor signal can preferably be transmitted in encrypted form, wherein the generation of the representative identifier (S5) can be performed by identification device 30 of mobile terminal 22.

The transmission of the sensor signal or the encrypted sensor signal or the identifier (S9) can then take place via communication device 24 of mobile terminal 22 and communication device 12 of motor vehicle 10. For this purpose, it can be provided, for example, that communication device 24 and communication device 12 can each have an NFC-capable chip. The user may then, for example, hold mobile terminal 22 to communication device 12 so that the corresponding signal can be transmitted.

After unlocking user profile S4, data server apparatus 28 may, for example, transmit an image signal to communication device 12 (S10), and the user may use the user profile via operation device 16, for example.

If identification feature I is, for example, an S-PIN or a serial number of mobile terminal 22, then said S-PIN or serial number can be transmitted, for example, from communication device 24 of mobile terminal 22 to sensor device 20 of motor vehicle 10. Alternatively, such an identification feature I can be transmitted to sensor device 20 via communication device 12.

Optionally, on the basis of the ascertained identity, motor vehicle system 18 can be controlled by, for example, generating a corresponding control signal for, for example, activating an auxiliary heater to motor vehicle system 18 by identification device 14 and transmitting it to motor vehicle system 18 (S11):

The embodiments described above illustrate the principle of the invention, enabling identification of the current motor vehicle user to personalize, for example, services/or access control. Such a user identification can take place, for example, by means of a fingerprint reader in and/or on or on motor vehicle 10.

An identification and/or authentication of a user can take place via a sensor device 20, 26, for example via a fingerprint reader in and/or on motor vehicle 10. Such an exemplary fingerprint reader may, for example, be comparable to a corresponding reader in current smartphones for unlocking the equipment.

The use of an identification feature I, for example a fingerprint, for identifying the user, i.e. for establishing the identity of the user (S2), can be used for the utilization of personalized services. Alternatively or additionally, for example, a utilization for authentication for a remote-controlled function for opening or closing motor vehicle 10 can take place (the so-called “remote lock/unlock” function).

According to a further exemplary embodiment, the enabling of the user profile S4, a so-called “login”, can take place, for example, in a computer program by way of a fingerprint as an identification feature I, for example with a fingerprint reader in the smartphone, and/or an input of, for example, an S-pin in mobile terminal 22 for authentication of safety-critical services, such as an auxiliary heater or the “remote lock/unlock” function.

The exemplary fingerprint can be linked, for example, as an identifier and/or with, for example, an encrypted checksum and replace other ID transmitters at many locations in and/or on motor vehicle 10, i.e., other access codes (“credentials”) or, such as a password, a user ID, or “logins”.

Via identification feature I, for example, the personal fingerprint, all people, meaning both drivers and/or users are identifiable without mobile device 22. The exemplary fingerprint advantageously replaces, compared to motor-vehicle-external data server apparatus 28, for example a back-end, for example, an access code such as a user ID and/or a password (if previously linked thereto).

For user identification in the course of personalization of services, the following advantages result, among others: identification and/or authentication of offline users, even users without a mobile terminal 22 or with a mobile terminal 22 switched off; the identification and/or authentication is not dependent on a performance of a mobile terminal 22, for example, not even dependent on, for example, software problems of mobile terminal 22; for example, provided in a start-stop button, the identification can take place directly at the start of the engine or in the event of a failure of the ignition; a unique link of, for example, fingerprint and user account, for example via mobile terminal 22, which may comprise, for example, a fingerprint reader, enables user identification in all motor vehicles 10; increased protection of vehicle profiles and profile data, since an identification feature I can not be stolen or read, wherein protection may be important because a vehicle profile may still contain, for example, credit card information and other personal data; identification in, for example, in-car purchases (for example in an in-car web shop) can also be done conveniently via identification feature I; from the identification of online updates in motor vehicle 10; identification and/or authentication are also possible while driving and not prevented due to a distraction of the user, since the driver is hardly distracted by it; identification and/or authentication for, for example, an access control in which sensor device 20 is arranged on motor vehicle 10, for example on the door handle, and can replace an ID transmitter for unlocking, for example, motor vehicle 10, and no ID transmitter must be used for unlocking motor vehicle 10.

Identification with, for example, a fingerprint eliminates annoying and repetitive queries of identification features I, for example of a password, for the user, and the convenience for the personalized utilization of online services is considerably increased.

For example, according to another exemplary embodiment, a function may be provided in an application program (“app”), for example, may be provided via an encrypted checksum of a personal fingerprint with a personal user account.

According to a further exemplary embodiment, for example, a back-end function in motor vehicle 10 for linking the user profile and/or the user profile at a data server of the motor vehicle manufacturer can take place via, for example, a fingerprint, for example for a user who has no mobile terminal 22.

According to a further exemplary embodiment, sensor device 20, for example the exemplary fingerprint reader, may be located in a start-stop button of motor vehicle 10, for example for identification when switching a terminal of the ignition system, and/or for enabling a vehicle start.

In a further exemplary embodiment, sensor device 20 may be located, for example, in an outside door handle for the identification and/or authentication of a user to unlock motor vehicle 10 and thus replace a remote control of the lock.

In a further exemplary embodiment, matching, for example, of a fingerprint read by a start-stop button and/or a checksum of the fingerprint can be done, for example with a local profile database or online with data server apparatus 28 for downloading a profile.

In other words, the identification of a user can take place via the identification feature offline in motor vehicle 10 or online via data server apparatus 28 and thus enabling a personalized profile for the utilization of online services can take place.

1-9. (canceled)

10. A method for operating a communication device of a motor vehicle, which is adapted to provide a data communication connection to a motor-vehicle-external data server apparatus and to communicate with the motor-vehicle-external data server apparatus, comprising the steps:
capturing by a sensor device an identification feature, on the basis of which a user of a user profile is identifiable, wherein the identification feature is a feature of a mobile terminal of the user or a feature of the user,
establishing, on the basis of the captured identification feature, an identity of the user by an identification device of the motor vehicle,
establishing, by the identification device and depending on the established identity, an access code for the user profile of the user, wherein the at least one access code is stored in a database, and
enabling, by the established access code, the ascertained user profile for the communication apparatus.

11. The method of claim 10, wherein a biometric feature of the user is captured as an identification feature, preferably a fingerprint of the user.

12. The method according to claim 10, wherein the establishing of the identification of the identity is carried out comprising the following steps:
generating an identifier that represents the identification feature by the identification device,
transmitting the generated identifier to the motor-vehicle-external data server apparatus for ascertaining the identity, and
receiving an authentication signal from the motor-vehicle-external data server apparatus, which describes the identity determined by the motor-vehicle-external data server apparatus, wherein the establishing of the identity by the identification device takes place on the basis of the authentication signal.

13. The method according to claim 10, wherein the establishing of the identity comprises the following steps:
generating an identifier that represents the identification feature by an identification device of the mobile terminal, and
transmitting the generated identifier to the identification device of the motor vehicle for establishing the identity.

14. The method according to claim 12, wherein generating the identifier that represents the identification feature comprises creating a cryptographic hash function as identifier, preferably creating a checksum and/or a hex string and/or a hash code by a SHA1 algorithm and/or a md5 checksum.

15. The method according to claim 10, comprising the step:
generating a control signal for activating to control a motor vehicle system of the motor vehicle, depending on the established identity and a predetermined function of the user profile for activating to control a motor vehicle system, and
transmitting the control signal to the motor vehicle system, wherein the motor vehicle system is preferably configured as an auxiliary heater and/or as a motor vehicle system for starting and/or stopping an engine and/or as an ignition device.

16. An identification device, comprising a processor device, wherein the processor device is adapted to carry out the method steps of a method according to claim 10 relating to an identification device.

17. A motor vehicle, comprising an identification device according to claim 16, and a communication device.

18. The motor vehicle according to claim 17, comprising a sensor device for capturing the identification feature, preferably wherein a sensor of the sensor device is arranged on a door handle of the motor vehicle and/or on a motor vehicle system of the motor vehicle, in particular on an operating element of the motor vehicle system for starting and/or stopping an engine and/or an ignition device of the motor vehicle, and/or on a reader.
